(19) United States
(12) Patent Application Publication
(10) Pub. No.: US 2003/0221459 A1
(43) Pub. Date: Dec. 4, 2003

(54) Method for forming an optical waveguide fiber preform

(76) Inventor: Wanda J. Walczak, Big Flats, NY (US)

Correspondence Address: CORNING INCORPORATED, SP-TI-3-1, CORNING, NY, 14831

(21) Appl. No.: 10/159,678

(22) Filed: May 31, 2002

(51) Int. Cl. C03B 37/075

(52) U.S. Cl. 65/398

(57) ABSTRACT

A method of producing a doped optical fiber preform from a silica-based preform is disclosed which includes, in a first gas exposure step, exposing the silica soot portion to a first gaseous environment containing a chlorine-containing compound for a time and at one or more temperatures below the consolidation temperature of the silica soot portion, in a second gas exposure step, exposing the silica soot portion to a second gaseous environment containing a second gaseous compound for a time and at one or more temperatures below the consolidation temperature of the silica soot portion, and in a third gas exposure step, exposing the silica soot portion to a third gaseous environment containing a chlorine-containing compound for a time and at one or more temperatures below the consolidation temperature of the silica soot portion and higher than at least one of the temperatures in the first gas exposure step.

### FIELD OF THE INVENTION

The present invention relates to optical waveguides, and, more particularly, to methods for forming optical waveguide preforms and optical fiber drawn therefrom.

### BACKGROUND OF THE INVENTION

Various methods of drying optical waveguide preforms are known.

Optical waveguides or fibers formed of glass may be drawn from an optical waveguide preform at suitable drawing temperatures, typically between about 1600 and 2150° C. Commonly, an optical fiber is formed having a core of a first material and a cladding of a second material. At drawing temperatures, the core material and the cladding material may have different viscosities from one another. The layer having a higher viscosity may be placed under tensile stress in the fiber once the fiber has cooled. Such tensile stresses may induce weaknesses that make the fiber or portions thereof subject to mechanical and/or optical failure during manufacture or in use. Where the viscosity of the core material is greater than that of the cladding material, such tensile stresses may increase the attenuation in or otherwise diminish the optical properties of the core. A portion of a preform, such as a portion corresponding to the core of the fiber, may be doped with chlorine to reduce the viscosity of the portion during draw.

A portion of a preform, such as a portion of corresponding to the core of a fiber drawn from the preform, may be doped with germanimum and/or fluorine compounds to achieve refractive index tuning and/or to match viscosity between the core and adjacent regions, as discussed for example in “Scattering Property of F and GeO₂ codoped silica glasses” by K. Tsujikawa et al., Electronics Letters, Vol. 30, No. 4, p.351, Feb. 17, 1994. Matching the viscosity can have a significant effect on the reduction of imperfection losses, resulting in optical fibers with lowered attenuation. See “Imperfection Loss Reduction in Viscosity Matched Optical Fibers”, IEEE Photonics Technology Letters, Vol. 5, No. 7, July 1993. Also see U.S. Pat. No. 4,125,388 to Powers for a discussion on using chlorine for drying prior to fluorination. U.S. Pat. Nos. 4,812,155 and 5,221,309 to Kyoto et al. describe using chlorine concurrently with fluorination to eliminate muffle contaminants. Fluorine lowers or depresses the refractive index (a “downdopant”) while chlorine (or, for example, germania) increases or raises the refractive index (an “updopant”). Furthermore, the effect of chlorine on viscosity is less than that of fluorine. FIG. 3 of European Patent Application EP 0762159 A2 illustrates a figure of dopant effect on viscosity for Cl, F, OH, and TiO₂.

### SUMMARY OF THE INVENTION

A method of producing a doped optical fiber preform from a silica-based preform having a silica soot portion, the method comprising: in a first gas exposure step, exposing the silica soot portion to a first gaseous environment containing a chlorine-containing compound for a time and at one or more temperatures below the consolidation temperature of the silica soot portion; in a second gas exposure step, exposing the silica soot portion to a second gaseous environment containing a second gaseous compound for a time and at one or more temperatures below the consolidation temperature of the silica soot portion; and in a third gas exposure step, exposing the silica soot portion to a third gaseous environment containing a chlorine-containing compound for a time and at one or more temperatures below the consolidation temperature of the silica soot portion and higher than at least one of the temperatures in the first gas exposure step.

Preferably, the silica soot portion comprises at least one dopant.

In one preferred embodiment, the silica soot portion has greater than 0.005 wt % chlorine after the third gas exposure step. In another preferred embodiment, the silica soot portion has greater than 0.010 wt % chlorine after the third gas exposure step. Preferably, the silica soot portion comprises a germanium compound prior to the first gas exposure step.

In another preferred embodiment, the silica soot portion has greater than 0.030 wt % chlorine after the third gas exposure step. Preferably, the silica soot portion comprises greater than 3 wt % germanium compound prior to the first gas exposure step.

In yet another preferred embodiment, the silica soot portion has greater than 0.040 wt % chlorine after the third gas exposure step. Preferably, the silica soot portion comprises greater than 5 wt % germanium compound prior to the first gas exposure step.

In still another preferred embodiment, the silica soot portion has greater than 0.100 wt % chlorine after the third gas exposure step. Preferably, the silica soot portion comprises greater than 15 wt % germanium compound prior to the first gas exposure step.

In yet another preferred embodiment, the silica soot portion has greater than 0.110 wt % chlorine after the third gas exposure step. Preferably, the silica soot portion comprises greater than 17 wt % germanium compound prior to the first gas exposure step.

In a preferred embodiment, the first gaseous environment has a temperature less than or equal to about 1000° C.

In a preferred embodiment, the second gaseous environment has a temperature between about 1000° C. and about 1250° C.

Preferably, at least one temperature of the second gaseous environment is higher than the one or more temperatures in the first gas environment.

Preferably, substantially all of the temperatures in the second gaseous environment are greater than any temperature in the first gaseous environment.

In a preferred embodiment, the second gaseous compound is a compound selected from the group consisting of F₂, SiF₄, CF₄, C₂F₆, SF₆, C₃F₈, NF₃, ClF₃, BF₃, chlorofluorocarbons, and O₂. Preferably, the second gaseous compound is a fluorine-containing compound. Preferably, the second gaseous environment also includes a chlorine-containing compound. In a preferred embodiment, the second gaseous environment comprises a fluorine-containing compound and a chlorine-containing compound.

In one preferred embodiment, the second gaseous compound is a chlorine-stripping compound.

Preferably, the chlorine-containing compound is a compound selected from the group consisting of Cl₂, GeCl₄, SiCl₄, CCl₄, SOCl₂, and POCl₃.

The method further preferably comprises heating at least a portion of the preform and consolidating the silica soot portion. The method further preferably comprises reducing the partial pressure of one or more unreacted compounds exposed to the silica soot portion prior to consolidation of the silica soot portion. In a preferred embodiment, the method further comprises reducing the partial pressure of any chlorine-containing compound exposed to the silica soot portion prior to its consolidation. In another preferred embodiment, the method further comprises heating at least a portion of the preform to a draw temperature and drawing optical fiber therefrom.

In a preferred embodiment, the method further comprises heating at least a portion of the preform, consolidating the silica soot portion, and drawing optical fiber from the preform.

Preferably, the method further comprises, before the third gas exposure step, reducing the partial pressure of the second gaseous compound in the environment exposed to the silica soot portion. In a preferred embodiment, the method further includes, before the third gas exposure step, reducing the partial pressure of the chlorine-stripping compound in the environment exposed to the silica soot portion.

In one preferred embodiment, the method further comprises, before the third gas exposure step, purging the environment exposed to the silica soot portion with an inert gas.

Preferably, at least one of the first, second and third gaseous environments further comprises an inert gas. Preferably, the inert gas comprises a gas selected from the group consisting of argon, helium, and nitrogen.

In at least one preferred embodiment, the silica-based preform has an inner surface defining a throughhole. In one preferred embodiment, the inner surface is exposed to at least one of the first, second and third gaseous environments. In another preferred embodiment, the inner surface is sealed from exposure to at least one of the first, second and third gaseous environments.

Objects of the present invention will be appreciated by those of ordinary skill in the art from a reading of the figures and the detailed description of the preferred embodiments which follow, such description being merely illustrative of the present invention.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a schematic cross-sectional representation of a preform disposed in a furnace to be processed by the method disclosed herein;

FIG. 2 is a schematic representation of an apparatus including a furnace for performing the method disclosed herein;

FIG. 3 shows a comparative example of measured concentrations (wt %) of Ge, F, and Cl in a preform;

FIG. 4 shows measured preform concentrations (wt %) of Ge, F, and Cl in accordance with the method disclosed herein;

FIG. 5 shows the chlorine concentrations (wt %) from FIG. 3 and FIG. 4 for comparison;

FIG. 6 shows a portion of the chlorine concentrations (wt %) from FIG. 5 on an expanded scale;

FIG. 7 shows the fluorine concentrations (wt %F) from FIGS. 3 and 4.

### DETAILED DESCRIPTION OF THE INVENTION

The present invention now will be described more fully hereinafter with reference to the accompanying drawings in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Methods and apparatus according to the present invention may be used to provide enhanced levels of chlorine doping and/or lowered water or hydroxyl ion concentrations in an optical waveguide preform, such as an optical fiber preform. The chlorine-doped soot preform, or chlorine-doped soot portion of the preform, may in turn be consolidated to form a glass optical fiber preform, or a layer of a glass optical fiber preform, wherein the preform or layer exhibits an enhanced level of chlorine doping.

In the case of a multi-layer optical waveguide preform, the enhanced level of chlorine doping in the chlorine-doped layer may provide a corresponding reduction in the viscosity of the layer in a selected draw temperature range, which may in turn provide improved viscosity matching or refractive index tuning between the chlorine-doped layer and another layer of the glass preform in the draw temperature range. The improved viscosity matching or tuning may reduce or minimize the tensile or compressive stresses resulting from differential viscosities during the process of drawing a fiber from the glass optical waveguide preform or may allow for selective and desired creation and control of such stresses. The chlorine doping may provide the foregoing effect without appreciably altering the refractive index of the chlorine-doped layer.

Enhanced chlorine doping of a soot preform, or soot portion of a preform, may also be advantageous for reducing thermal stress from linear thermal expansion (LTE) mismatch, reducing mechanical stress from viscosity mismatch, lowering impurities, and controlling refractive index.

Lowering the viscosity in a non-light-carrying region, such as the overclad region, can reduce the temperature at which optical fiber may be drawn and is thought to reduce defects generated at draw. Updoping a silica overclad region can lower cutoff wavelength.

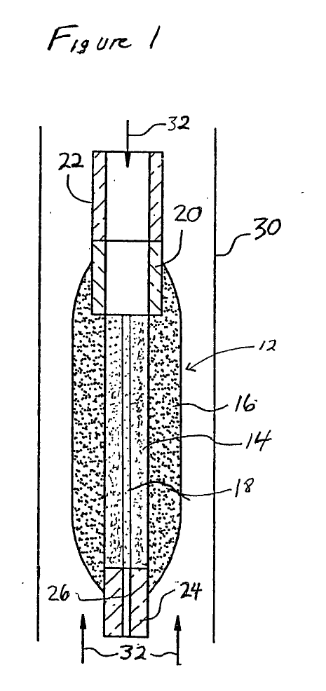

FIG. 1 schematically shows a cross-sectional view of an optical fiber preform 12 disposed in a furnace 30 having an inner surface 31 defining a chamber 33 adapted to contain the preform and including a heater for heating the chamber disposed at, in, on, around, or near the wall of the furnace defining the chamber. As exemplary shown in FIG. 1, preform 12 is comprised of a silica soot core region 14 and a silica soot cladding region 16. Thus, the silica soot portion of the preform 12 in this exemplary embodiment includes core region 14 and cladding region 16.

Preform 12 may be formed from any known technique to form a soot body. These techniques include, but are not limited to, outside vapor deposition (OVD), vapor axial deposition (VAD), modified chemical vapor deposition (MCVD), plasma chemical vapor deposition (PCVD), or any other known technique, such as sol-gel processing. For example, U.S. Pat. No. 3,933,454 discloses suitable methods and apparatus for forming a soot preform. OVD, VAD, MCVD, and PCVD may be commonly referred to as chemical vapor deposition (CVD) techniques.

Preferably, soot is deposited on a starting member to form preform 12. The starting member may be a mandrel, a glass rod or cane, a glass tube, or other substrate upon which the soot may be deposited. The starting member may be removed from the preform body, as in the example of a mandrel, or the starting member or a portion thereof may form an integral part of the optical fiber preform to be drawn into optical fiber, as in the example of a glass rod or glass tube, at least a portion of is suitable for subsequently drawing into optical fiber, in which case the preform may comprise a glass portion and a silica soot portion before the silica soot portion is consolidated.

Soot particles deposited on the starting member are typically less than about 20 microns, preferably less than about 12 microns, more preferably about 0.1 to about 1.0 microns, most preferably about 0.1 to about 0.3 microns.

As illustrated in FIG. 1, preform 12 may generally have a core region 14 surrounded by a cladding region 16. Optionally, preform 12 may have a near cladding region (not shown) disposed between the core region and the cladding region. Preform 12 may have an axial throughhole in its core 14, such as centerline hole or center passage 18, for example if a mandrel had served as the starting member and had been removed from the preform. Core region 14 is preferably composed of silica or doped silica. For example, core region 14 may be doped with a germanium compound to increase the refractive index of core region 14. Core region 14 may instead, or also, include a second dopant such as fluorine or more preferably an annular fluorine doped region. Other potential soot dopants include alkali metal oxides, alkaline earth oxides, transition metals, alumina, antimony oxide, boron oxide, gallium oxide, indium oxide, tin oxide, lead oxide, phosphorus oxide, arsenic oxide, bismuth oxide, tellurium oxide, selenium oxide, titanium oxide, and mixtures thereof. Core region 14 may be constructed of a plurality of doped and undoped regions of soot, in particular silica soot. In one preferred embodiment, preform 12 includes at least one germanium doped region. In another preferred embodiment, preform 12 includes at least two germanium doped regions.

Cladding region 16 typically includes at least silica. Cladding region 16 may have a refractive index lower than the refractive index of core 14 or lower than at least one layer of the core region 14.

The invention is not limited to the aforementioned materials of construction for core region 14 and cladding region 16. Preform 12 may be constructed from any oxide based glass.

As depicted in FIG. 1, preform 12 has a handle 20 preferably made of glass for use in handling and/or mounting the preform 12 during transport or processing. The handle 20 is preferably fused to a standard ball joint handle 22. A plug 24, with an optional capillary tube 26, both preferably made of glass, are disposed at a distal end of the preform 12 opposite the handle 20. Preform 12 may be suspended in furnace 30 by handle 20.

By way of example, it may be desired to form an optical waveguide or optical fiber having a core region comprising an inner layer or a central core of GeO₂SiO₂ and another layer of F—SiO₂ surrounding the central core. A consolidated glass optical fiber preform from which the optical fiber is to be drawn must likewise have a core or inner layer of GeO₂—SiO₂ and an outer layer of F—SiO₂. After heating the glass optical fiber preform to a draw temperature and drawing optical fiber therefrom, the central core of the cooled optical fiber may be under tensile stress by the outer layer if the GeO₂—SiO₂ of the glass optical preform central core had a higher viscosity than the F—SiO₂ of the glass optical preform outer layer during draw. However, doping the central core of the glass optical preform with chlorine may lower the viscosity of the central core to match the viscosity of the outer layer, or even to be less than the viscosity of the outer layer so that the core is under less (and preferably zero) tension or compression in the cooled optical fiber. In one embodiment, the outer layer corresponds to a moat region of the core having a refractive index lower than an adjacent region. In another embodiment, the outer later may be a cladding layer, such as a so-called near-cladding.

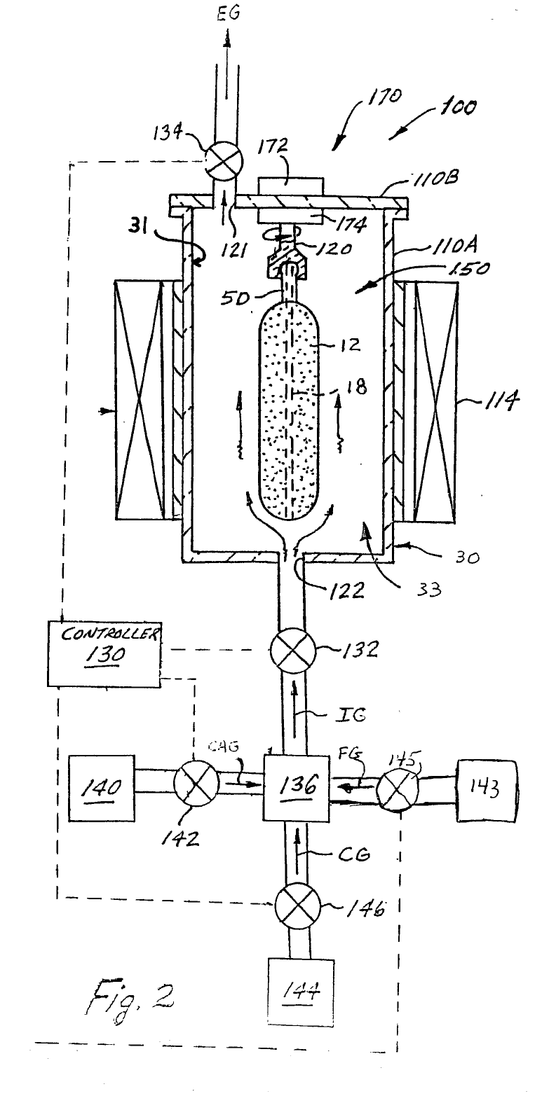

A silica soot preform or a silica-based preform having a silica soot portion may be doped and consolidated according to a method as disclosed herein, for example with an apparatus 100 as schematically illustrated in FIG. 2.

Thus, the preform 12 may comprise pure silica or may comprise doped silica, or at least one layer of pure silica and at least one layer of doped silica. The silica may be doped with Ge, Al, F, B, Er, Ti, P and/or Sb and/or mixtures thereof, and/or compounds thereof, and/or mixtures thereof. For example, the preform 12 may include suitable glass modifiers or glass formers such as SiO₂, Al₂O₃, Er₂O₃, TiO₂, F, or GeO₂. The silica soot portion of the preform 12 is a porous structure defining a plurality of interstices. The preform 12 includes a passage 18 extending the full length thereof from which a mandrel of the chemical vapor deposition apparatus has been removed, for example when the preform is made according to an outside vapor deposition (OVD) process. The preform 12 may include a glass preform handle 20 as illustrated which preferably includes a ball joint handle portion 22.

The apparatus 100 includes a furnace 30 having an inner surface 31 defining a chamber 33 adapted to receive the preform 12. The furnace 30 preferably includes an annular muffle 110A and an end cover 110B. A shaft 120 extends from the end cover 110B and into the chamber 33. A drive system 170, preferably mounted on the furnace 30, preferably includes a drive motor 172 mounted on the exterior side of the end cover 110B and a transmission unit 174 mounted on the interior side of the end cover 110B. The drive motor 172 may be magnetically coupled to the transmission unit 174 through the end cover 110B such that the transmission rotates the shaft 120 and thereby the preform 12, preferably about a vertical axis. Preferably, the chamber 33 and the preform 12 are substantially completely surrounded by a pure silica muffle 110A.

Thus, the preform 12 is placed in the chamber 33 and suspended from the shaft 120. If rotation is provided, the preform 12 may be suspended from the handle 120 for rotation therewith.

In a first gas exposure step, the preform 12 is preferably exposed to a first gaseous environment containing a first gaseous compound for a time and at one or more temperatures below the consolidation temperature of the silica soot portion of the preform 12. Preferably, the first gaseous environment is a drying or dehydrating environment which preferably includes heating the preform inside the furnace and passing a flow of suitable drying gas through the chamber 33 and about the preform 12 to remove water and/or hydroxyl ions from the silica soot portion of the preform 12. If the preform 12 contains a throughhole such as an axial centerline hole 18, then the drying gas may be provided within the throughhole.

Preferably, the drying gas is a chlorine-containing gas. Preferably, the chlorine-containing drying gas is Cl₂, with other suitable chlorine-containing drying gases including GeCl₄, SiCl₄, CCl₄, SOCl₂ and POCl₃. Even more preferably, the drying gas also includes one or more inert gases, such as helium, argon, nitrogen, or mixtures thereof.

Preferably, the drying gas is provided at a flow rate of between about 5 and 50 slpm, more preferably between about 10 and 40 slpm. Preferably the preform 12, or at least the silica soot portion of the preform, or a part thereof, is exposed to the drying gas for a time of between about 15 minutes and about 6 hours, more preferably between about 15 minutes and about 4 hours, even more preferably between about 30 minutes and about 2 hours, still more preferably between about 30 and 90 minutes, while the preform 5 is heated or maintained at an elevated temperature by setting the furnace temperature to a temperature or within a temperature range less than the consolidation temperature of the silica soot portion, preferably less than about 1200° C., more preferably less than or equal to about 1000° C., thereby heating the silica soot portion of the preform to a desired first drying temperature or first drying temperature range.

The chamber 33 may be heated using a heating device 114 (e.g., a resistive heater or an inductive coil heater). Alternatively, or in addition, the drying gas may be heated prior to entry into the furnace. The flow of drying gas may be provided using a fluid control system 152 as described below or other suitable means.

Preferably, the preform is heated to a drying temperature of about 900° C. to about 1200° C., more preferably about 1000° C. to about 1100° C. Preferably, the atmosphere in furnace 30 during the drying operation is substantially devoid of any fluorine containing compounds.

In a second gas exposure step, the preform 12, or at least the silica soot portion of the preform or a part thereof, is preferably exposed to a second gaseous environment containing a second gaseous compound for a time and at one or more temperatures below the consolidation temperature of the silica soot portion. The second gaseous compound may be a compound which tends to strip chlorine out of the silica soot portion, such as a compound that introduces fluorine or oxygen into the the silica soot portion. In a preferred embodiment, the second gaseous compound is a fluorine-containing compound, wherein at least part of the silica soot portion becomes doped with fluorine in the second gas exposure step. Thus, the silica soot portion may preferably be exposed to fluorine-containing doping gas which includes at least one of the following gases: SiF₄, CF₄, C₂F₆, SF₆, F₂, C₃F₈, NF₃, ClF₃, BF₃, chlorofluorocarbons, and mixtures thereof.

Fluorine doping is preferably accomplished in the second gas exposure step by placing or keeping the preform 12 in a furnace which is set to a furnace temperature or temperature range from about 900° C. to about 1300° C., more preferably from about 1000° C. to about 1275° C., thereby heating the silica soot portion of the preform to a desired doping temperature or temperature range. A doping atmosphere 150 may be provided in the chamber 33 of the furnace 30 as illustrated in FIG. 2. The fluorine-containing doping gas is introduced into the chamber of the furnace, preferably once the silica soot portion has been heated to an appropriate doping temperature, although the doping gas may be introduced before the silica soot portion reaches an appropriate doping temperature. The silica soot portion of the preform 12 is exposed to the doping gas for a period ranging preferably from about fifteen (15) minutes to about six (6) hours, more preferably from about thirty (30) minutes to about four (4) hours.

Preferably, the second gaseous environment includes a chlorine-containing compound.

Preferably, after doping the silica soot portion with fluorine, in a third gas exposure step, the silica soot portion is then exposed to a third gaseous environment containing a chlorine-containing compound for a time and at one or more temperatures below the consolidation temperature of the silica soot portion and higher than at least one of the temperatures in the first gas exposure step, more preferably below the consolidation temperature of the silica soot portion and higher than any of the temperatures in the first gas exposure step. Preferably, the silica soot portion is exposed to the chlorine-containing compound for a time and at a temperature sufficient to chlorine dope at least part of the silica soot portion, and/or the silica soot portion is exposed to the chlorine-containing compound for a time and at a temperature sufficient to dry or dehydrate at least part of the silica soot portion.

By way of example, the doping atmosphere 150 may be provided by the fluid control system 152 illustrated in FIG. 2. The fluid control system 152 includes a controller 130, a chamber inlet valve 132, a chamber outlet valve 134, a supply 140 of carrier gas IG, a carrier gas valve 142, a supply 144 of a chlorine-containing gas CG (i.e., a gas including a chlorine-containing compound), a chlorine gas valve 146, a supply 143 of fluorine-containing gas FG (i.e., a gas including a fluorine-containing compound) and a fluorine gas valve 145. The valves 132, 134, 142, 143, and 146 may be controlled by the controller 130. Connecting device 136 may be a tee connection, a mixing valve, a shut off valve, or other device implemented to achieve desired flow control. Other valving and gas supply arrangements are also contemplated as known by the skilled artesan.

For example, valves 132 and 134 may be initially opened to provide a flow path from inlet 122, through the chamber 33 and to outlet 121. Valves 142 and 146 may be selectively operated to control an inlet gas mixture IG that may include desired proportions of the carrier gas CG, the chlorine-containing gas CG, and/or the fluorine-containing gas FG, and to introduce the inlet gas mixture IG into the chamber 112. Valve 134 may be left in the open position until the atmosphere previously in the chamber 38 discharges, or is purged, so that for example, the chamber 33 is substantially completely filled with the inlet gas IG.

The controller 130 further operates the heating device 114 to heat the atmosphere 150 to a selected set temperature or temperature range. The outlet valve 134 may be closed to maintain the atmosphere 150. The valve 132 may also or alternatively be closed to maintain the atmosphere 150. Valves could be operated manually without controller 130.

It will be appreciated by those of skill in the art from the description herein that other methods for providing the desired atmosphere 150 with a desired temperature or temperature range.

Preferably, a slightly elevated pressure in the chamber 33 may be provided, e.g. to help prevent the ingress of any contaminants or undesired gases from the area surrounding the apparatus 100 which would be the local atmospheric pressure, e.g. the atmospheric pressure surrounding the apparatus 100, e.g. the atmospheric pressure at the elevation above sea level at a particular locale, wherein the atmospheric pressure at sea level is about 101 kPa.

The set temperature and the reacting time are selected to provide a selected level of drying and/or doping to the silica soot portion of the preform 12. For example, chlorine present in the furnace reacts with and diffuses into the porous silica soot portion of the preform 12 such that the silica soot portion is doped with an elevated level of chlorine. The preform 12 may be rotated during the reacting time.

Exhaust valve 134 may be maintained closed, open, or selectively controlled by opening and closing, either fully or partially, to maintain a substantially constant, or a variable, partial pressure PP of the chlorine-containing gas or the fluorine-containing gas. Preferably, the doping partial pressure PP of the chlorine-containing gas CG or the fluorine-containing gas FG is maintained substantially constant throughout the reacting time, for example, by the addition of chlorine-containing gas or the fluorine-containing gas into the chamber while maintaining the exhaust valve 134 closed.

The weight percentage of chlorine present in the doped preform 12 may be selected as needed to match viscosity, linear thermal expansion (LTE), refractive index, and/or other selected properties.

At the end of the reacting time, the doping atmosphere 150 is preferably expelled. Exhaust gases EG such as SiCl₄, GeO, Cl₂, O₂, He, Ar or N₂ may be expelled through the outlet 121 by opening the valve 134. If desired, the exposure step(s) may be repeated to further dope the preform 12.

Following the last doping step, the silica soot portion of the preform 12 is preferably consolidated (or “sintered”) to form a doped glass optical fiber preform.

Preferably, the concentration or partial pressure of any unreacted gases which may be in the furnace chamber, such as fluorine-containing compounds or chlorine-containing compounds, which may come into contact or otherwise be exposed to the silica soot portion of the preform is reduced prior to consolidation of the silica soot portion. Even more preferably, prior to consolidation, all chlorine-containing compounds are removed from the furnace chamber in which the silica soot portion is to be consolidated. Preferably, the silica soot portion is consolidated in an inert gas atmosphere, even more preferably an atmosphere containing one or more gases selected from the group consisting of helium, argon, and nitrogen. Preferably, the method disclosed herein comprises an outgas step after the third gas exposure step (wherein, for example, the third gas exposure step may be a chlorine-exposure, post-fluorine doping step) wherein unreacted gases such as fluorine-containing gases or chlorine-containing gases are allowed to escape and/or are forced to escape, e.g. by being purged with an inert gas or inert gas mixture.

The consolidation step may include heating the doped silica soot portion of the preform 12 in the chamber 33 using the heating device 114 and/or another heating device to consolidate the silica soot portion of the preform 12 using known or other suitable techniques. Preferably, the consolidation step includes heating the silica soot portion of the preform 12 in a furnace set to a furnace temperature range of from about 1300 to about 1600° C., more preferably from about 1400° C. to about 1500° C.

Preferably, the silica soot portion of the preform is consolidated for about one-half hour (0.5) to about six (6) hours. In a preferred embodiment, the consolidation time is about four (4) to about six (6) hours. However, the consolidation time period may vary depending on the consolidation temperature, the size and density of the soot portion, and the chemical composition of the preform. Consolidation may occur in the same furnace as drying or in a different furnace.

The consolidated glass optical fiber preform may be may be heated to a temperature of about 1800° C. or more and drawn into optical fiber. Alternatively, the consolidated glass optical fiber preform may be drawn and optionally sectioned to form a reduced diameter glass preform (or “glass cane”). A layer of silica soot may then be deposited onto the glass cane using a suitable deposition method or CVD method such as OVD. The soot coated core cane is also known as an overcladded preform or an overcladded core cane.

The soot layer may in turn be dried and doped as disclosed herein, then consolidated, or simply consolidated, to form a multi-layered glass preform. Selected layers of the preform may be selectively doped with chlorine, e.g. in embodiments where different layers, especially adjacent layers, would have undesirably different viscosities from one another at drawing temperatures, such as in the range of between about 1600 and 2150° C., without the added chlorine in one or more of the layers. That is, the chlorine doping of one or more layers may serve to provide closer matching of adjacent layers at the drawing temperatures than if one or more of the layers were not chlorine doped in accordance with the present invention.

In a preferred embodiment, at least one layer of an optical fiber preform or optical fiber is formed of chlorine-doped, SiO₂—GeO₂. Preferably, the innermost central region of an optical fiber preform or optical fiber is formed of chlorine-doped, SiO₂—GeO₂. Preferably, the outer layer is formed of F—SiO₂, more preferably chlorine-doped, F—SiO₂. Optionally, the inner layer may be formed of chlorine-doped silica and the outer layer fluorine-doped silica.

### EXAMPLES

### Example 1

### Comparative

A silica-based soot preform having a maxium radius, Rmax, was fabricated according to a known OVD process wherein the central core of the preform was doped up to a normalized radius (r/Rmax) of about 0.5, the central core being surrounded by a a layer of substantially pure silica, i.e. from a normalized radius of about 0.5 to 1.0.

The preform was placed in a furnace, helium gas was introduced into the furnace chamber at 40 slpm, and the furnace temperature was set to 1000° C. The preform was kept in the furnace for 60 minutes at a furnace temperature of 1000° C. while 40 slpm He gas flowed into the furnace chamber during a preheat step. Thereafter, in a drying step, a mixture of 0.9 slpm Cl₂ gas along with 40 slpm He gas was introduced into the furnace chamber while the furnace temperature was maintained at 1000° C. for 120 minutes. Thereafter, in a ramp step, the flow of He gas was reduced to 20 slpm and the flow of Cl₂ gas was reduced to 0, then the furnace temperature was ramped up from 1000° C. to 1225° C. over the course of 30 minutes. In a fluorine doping step, a mixture of 1.0 slpm SiF₄ gas along with 19 slpm He gas was introduced into the furnace chamber while the furnace temperature was maintained at 1225° C. for 30 minutes. Thereafter, the flow of SiF₄ gas was terminated, 40 slpm He gas was introduced into the furnace chamber, and the silica soot preform was downdriven into a furnace hot zone having a peak temperature of 1530° C. in order to consolidate the silica soot preform. The silica soot was exposed to chlorine-containing gas only during the drying step prior to the fluorine doping step.

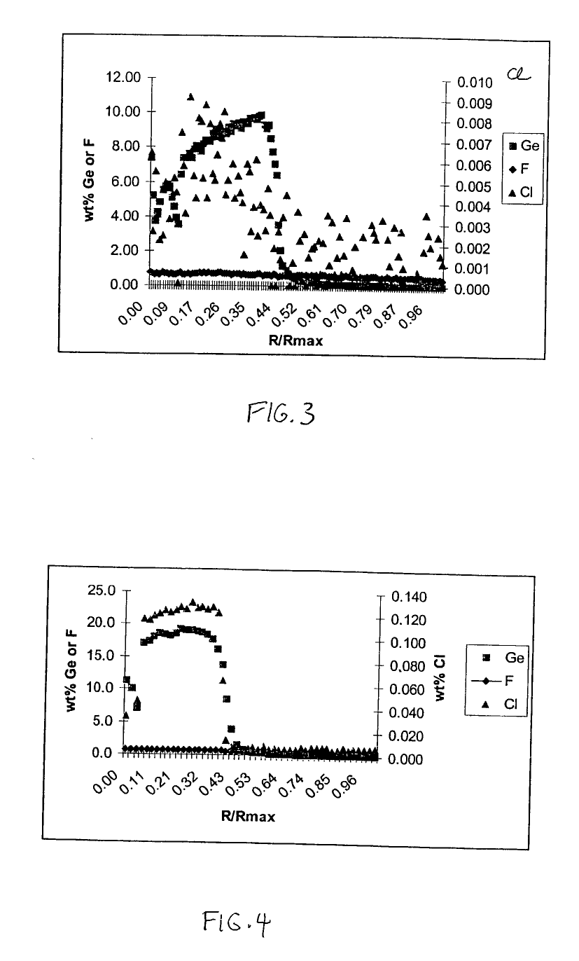

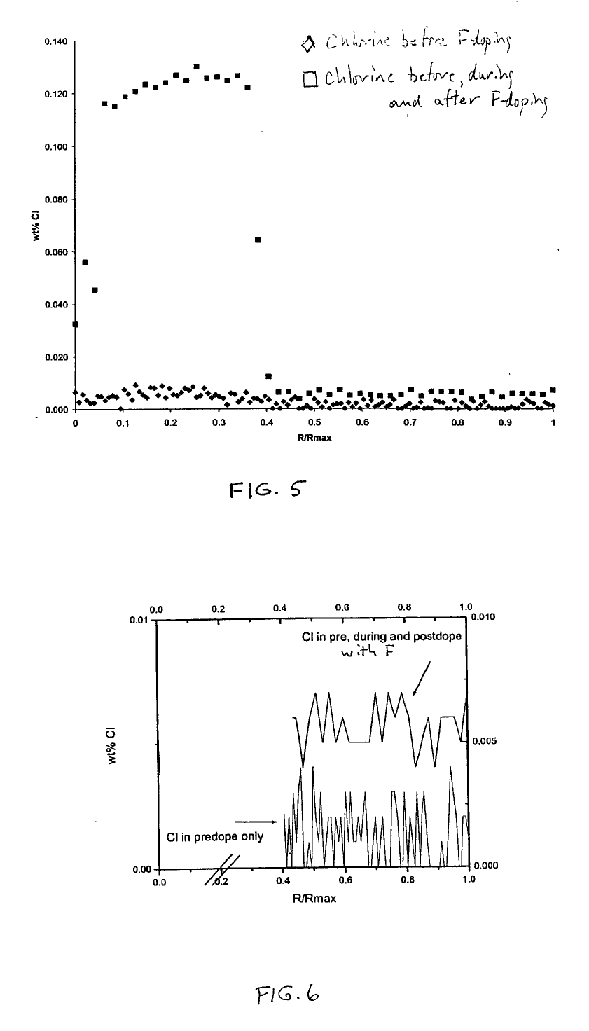

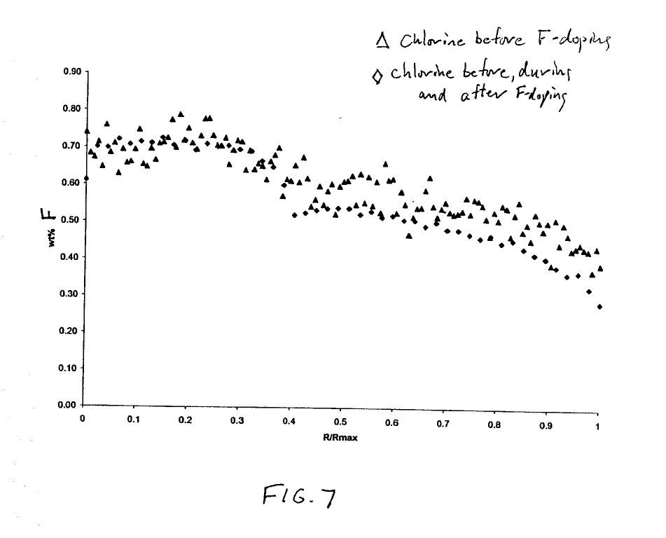

FIG. 3 shows measured values for wt % Ge, wt % F, and wt % Cl versus the normalized radius of the consolidated preform. Ge, F, and Cl are represented by the square, diamond, and triangle symbols, respectively. The preform contained Ge up to a normalized radius of about 0.5, as stated above, with a peak of about 10 wt % Ge at a normalized radius of about 0.4. As seen in FIGS. 3 and 7, the preform was also fluorine-doped, having between about 0.4 wt % F and about 0.8 wt % F, with fluorine present substantially throughout the entire preform. As perhaps best seen in FIG. 6, and also in FIGS. 3 and 5, the preform also contained slight amounts of chlorine, having between about 0.0 and about 0.004 wt % Cl.

The following example is intended to be exemplary of the method disclosed herein.

### Example 2

A silica-based soot preform having a maxium radius, Rmax, was fabricated according to a known OVD process wherein the central core of the preform was doped up to a normalized radius (r/Rmax) of about 0.5, the central core being surrounded by a a layer of substantially pure silica, i.e. from a normalized radius of about 0.5 to 1.0.

The preform was placed in a furnace, helium gas was introduced into the furnace chamber at 40 slpm, and the furnace temperature was set to 1000° C. The preform was kept in the furnace for 60 minutes at a furnace temperature of 1000° C. while 40 slpm He gas flowed into the furnace chamber during a preheat step. Thereafter, in a first gas exposure step or drying step, a mixture of 0.9 slpm Cl₂ gas along with 40 slpm He gas was introduced into the furnace chamber while the furnace temperature was maintained at 1000° C. for 60 minutes. Thereafter, in a ramp step, the flow of He gas was reduced to 20 slpm and the flow of Cl₂ gas was reduced to 0.45 slpm, then the furnace temperature was ramped up from 1000° C. to 1225° C. over the course of 30 minutes. In a second gas exposure step or a fluorine doping step, a mixture of 1.02 slpm SiF₄ gas along with 19 slpm He gas and 0.45 slpm Cl₂ gas was introduced into the furnace chamber while the furnace temperature was maintained at 1225° C. for 30 minutes. In a third gas exposure step or post-fluorine-doping or second drying or dehydrating step or chlorine doping step, the flow of SiF₄ gas into the furnace chamber was terminated, the flow of He gas into the furnace chamber was increased to 40 slpm, and the flow of Cl₂ gas into the furnace chamber was increased to 0.9 slpm (i.e. doubled over the fluorine doping step), while the furnace temperature was maintained at around 1225° C. Thereafter, the flow of Cl₂ gas into the furnace chamber was terminated, a mixture of 40 slpm He gas and 0.24 slpm CO gas was introduced into the furnace chamber, and the silica soot preform was downdriven into a furnace hot zone having a peak temperature of 1460° C. in order to consolidate the silica soot preform. The silica soot was thus exposed to chlorine-containing gas during first gas exposure step, i.e. the drying step prior to the fluorine doping step, during the second gas exposure step, i.e. the fluorine doping step, and in the third gas exposure step, i.e. after the fluorine doping step.

FIG. 4 shows measured values for wt % Ge, wt % F, and wt % Cl versus the normalized radius of the consolidated preform. Ge, F, and Cl are represented by the square, diamond, and triangle symbols, respectively. The preform contained Ge up to a normalized radius of about 0.5, as stated above, with a peak of about 19 wt % Ge at a normalized radius of about 0.25. As seen in FIGS. 4 and 7, the preform was also fluorine-doped, having between about 0.3 wt % F and about 0.75 wt % F, with fluorine present substantially throughout the entire preform. As perhaps best seen in FIG. 6, and also in FIGS. 4 and 5, the preform also contained chlorine, having between about 0.01 wt % Cl and about 0.13 wt % Cl in the Ge-doped region, and having greater than about 0.003 wt % Cl in the outer layer having a normalized radius between about 0.5 and 1.0. As seen in FIG. 6, chlorine concentrations of greater than 0.005 wt % Cl are present in the preform at normalized radii greater than 0.5. As also seen in FIG. 6, chlorine content of between about 0.004 wt % Cl and about 0.007 wt % Cl. is present at a normalized radius between about 0.5 and 1.0.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

What is claimed is:

1. A method of producing a doped optical fiber preform from a silica-based preform having a silica soot portion, the method comprising:
in a first gas exposure step, exposing the silica soot portion to a first gaseous environment containing a chlorine-containing compound for a time and at one or more temperatures below the consolidation temperature of the silica soot portion;
in a second gas exposure step, exposing the silica soot portion to a second gaseous environment containing a second gaseous compound for a time and at one or more temperatures below the consolidation temperature of the silica soot portion; and
in a third gas exposure step, exposing the silica soot portion to a third gaseous environment containing a chlorine-containing compound for a time and at one or more temperatures below the consolidation temperature of the silica soot portion and higher than at least one of the temperatures in the first gas exposure step.

2. The method according to claim 1 wherein the silica soot portion comprises at least one dopant.

3. The method according to claim 1 wherein the silica soot portion has greater than 0.005 wt % chlorine after the third gas exposure step.

4. The method according to claim 1 wherein the silica soot portion has greater than 0.010 wt % chlorine after the third gas exposure step.

5. The method according to claim 4 wherein the silica soot portion comprises a germanium compound prior to the first gas exposure step.

6. The method according to claim 1 wherein the silica soot portion has greater than 0.030 wt % chlorine after the third gas exposure step.

7. The method according to claim 6 wherein the silica soot portion comprises greater than 3 wt % germanium compound prior to the first gas exposure step.

8. The method according to claim 1 wherein the silica soot portion has greater than 0.040 wt % chlorine after the third gas exposure step.

9. The method according to claim 8 wherein the silica soot portion comprises greater than 5 wt % germanium compound prior to the first gas exposure step.

10. The method according to claim 1 wherein the silica soot portion has greater than 0.100 wt % chlorine after the third gas exposure step.

11. The method according to claim 10 wherein the silica soot portion comprises greater than 15 wt % germanium compound prior to the first gas exposure step.

12. The method according to claim 1 wherein the silica soot portion has greater than 0.110 wt % chlorine after the third gas exposure step.

13. The method according to claim 12 wherein the silica soot portion comprises greater than 17 wt % germanium compound prior to the first gas exposure step.

14. The method according to claim 1 wherein the first gaseous environment has a temperature less than or equal to about 1000° C.

15. The method according to claim 1 wherein the second gaseous environment has a temperature between about 1000° C. and about 1250° C.

16. The method according to claim 1 wherein at least one temperature of the second gaseous environment is higher than the one or more temperatures in the first gas environment.

17. The method according to claim 1 wherein the second gaseous compound is a compound selected from the group consisting of F₂, SiF₄, CF₄, C₂F₆, SF₆, C₃F₈, NF₃, ClF₃, BF₃, chlorofluorocarbons, and O₂.

18. The method according to claim 1 wherein the second gaseous compound is a chlorine-stripping compound.

19. The method according to claim 1 wherein the second gaseous environment comprises a chlorine-containing compound.

20. The method according to claim 1 or 19 wherein the chlorine-containing compound is a compound selected from the group consisting of Cl₂, GeCl₄, SiCl₄, CCl₄, SOCl₂, and POCl₃.

21. The method according to claim 1 further comprising heating at least a portion of the preform and consolidating the silica soot portion.

22. The method according to claim 21 further comprising reducing the partial pressure of one or more unreacted compounds exposed to the silica soot portion prior to consolidation of the silica soot portion.

23. The method according to claim 21 further comprising heating at least a portion of the preform to a draw temperature and drawing optical fiber therefrom.

24. The method according to claim 1 further comprising heating at least a portion of the preform, consolidating the silica soot portion, and drawing optical fiber from the preform.

25. The method according to claim 1 further comprising, before the third gas exposure step, reducing the partial pressure of the second gaseous compound in the environment exposed to the silica soot portion.

26. The method according to claim 1 further comprising, before the third gas exposure step, purging the environment exposed to the silica soot portion with an inert gas.

27. The method according to claim 1 wherein at least one of the first, second and third gaseous environments further comprises an inert gas.

28. The method according to claim 27 wherein the inert gas comprises a gas selected from the group consisting of argon, helium, and nitrogen.

29. The method according to claim 1 wherein the silica-based preform has an inner surface defining a throughhole.

30. The method according to claim 29 wherein the inner surface is exposed to at least one of the first, second and third gaseous environments.

31. The method according to claim 29 wherein the inner surface is sealed from exposure to at least one of the first, second and third gaseous environments.

32. The method according to claim 1 wherein the second gaseous environment comprises a fluorine-containing compound.

33. The method according to claim 1 wherein the second gaseous environment comprises a fluorine-containing compound and a chlorine-containing compound.
